(19) United States
(12) Patent Application Publication
(10) Pub. No.: US 2007/0006900 A1
(43) Pub. Date: Jan. 11, 2007

(54) Method and device for cleaning a beverage conduit in a dispensing system

(76) Inventor: Rudolf Till, Lauf-Aubach (DE)

Correspondence Address: HARNESS, DICKEY & PIERCE, P.L.C., P.O. BOX 828, BLOOMFIELD HILLS, MI, 48303, US

(21) Appl. No.: 11/472,264

(22) Filed: Jun. 21, 2006

Related U.S. Application Data
(63) Continuation of application No. PCT/EP04/13880, filed on Dec. 7, 2004.

(30) Foreign Application Priority Data
Dec. 23, 2003 (DE) 103 61 565.2

(51) Int. Cl. B08B 9/00; B08B 9/027; B08B 3/00

(52) U.S. Cl. 134/22.1; 134/166 C; 134/22.11

(57) ABSTRACT

A method and a device are used for cleaning a beverage conduit (5) in a dispensing system. The beverage conduit (5) is filled with a cleaning agent. A parameter (U_{M}) representing the cleaning condition of the beverage conduit (5) is measured during the cleaning of said beverage conduit (5), and the cleaning process is terminated when the parameter (U_{M}) reaches a predetermined setpoint value (U_{S}).

### CROSS REFENCES TO RELATED APPLICATIONS

The present application is a continuation of copending international application PCT/EP2004/013880 filed on Dec. 7, 2004 and designating the U.S., which claims priority of German patent application DE 103 61 565.2, filed on Dec. 23, 2003.

### BACKGROUND OF THE INVENTION

The invention relates to a method for cleaning a beverage conduit in a dispensing system, in which method the beverage conduit is filled with a cleaning agent and cleaned.

The invention relates further to a device for cleaning a beverage conduit in a dispensing system, with a cleaning system for filling the beverage conduit with a cleaning agent.

A method and a device of the kind mentioned above are known, for example from DE 297 04 794 U1.

In the known device, in order to clean a beverage conduit of a beer-dispensing system, a coupler is first knocked off the beer keg. By opening a valve, water from a water conduit is then first mixed with cleaning agent in a cleaning agent metering device and is then forced into the beverage conduit leading to the tap. An impeller meter ensures that the whole beverage conduit is filled with the cleaning agent mixture. After a predetermined downtime, the duration of which will be a matter of experience, the cleaning agent mixture is drained off again by opening a further valve, and the beverage conduit is filled several times with water and flushed.

A further device of the kind mentioned above is also known from WO 01/94040. In this known device, a beverage tank is connected to a tap via a beverage conduit in which, near the end remote from the beverage tank, a conductivity meter, a valve unit, a pump and a cooling unit are arranged. The aforementioned units are bridged by a circulation conduit. With the known device, a cleaning program known per se is executed in which a cleaning liquid is first introduced into the beverage conduit, is then left to stand for a certain period of time in the beverage conduit, and is then forced out by water into an outflow. Thereafter, the beverage conduit is filled several times with water and flushed by this. Finally, beverage is introduced again into the beverage conduit and, in this way, the water contained in it is forced out. The conductivity meter detects which liquid (beverage, cleaning liquid or water) is located in the beverage conduit, specifically at the site where the conductivity meter is located. The conductivity meter thus controls the change-over from one step of the cleaning program to a next step.

The known devices thus have the disadvantage that the presence of a defined medium is detected only at one position of the beverage conduit. The extent of the cleaning is by contrast still dependent on empirical values. It is thus not possible to guarantee that in fact the entire beverage conduit has been completely cleaned. Moreover, it is known that the extent of soiling of a beverage conduit depends on many factors, for example on the consistency of the particular beverage and on the temperature of the beverage conduit in the interval between the cleaning processes, in other words on factors which even with experience cannot be reliably evaluated.

A further disadvantage of the known device is that, at the end of the flushing process following on from the cleaning process, it is also not possible to ensure that the beverage conduit is now free of cleaning agent residues. There is therefore a danger that, when tapping operations recommence, cleaning agent residues will get into the tapped beverage.

### SUMMARY OF THE INVENTION

One of the objects of the invention is therefore to develop a method and a device, of the kind mentioned at the outset, in such a way as to avoid the stated disadvantages. It should in particular be possible for beverage conduits to be cleaned to a predetermined extent, both reliably and reproducibly, and to avoid situations where the beverage that is tapped after the cleaning process is contaminated with cleaning agent residues.

In a method of the kind mentioned at the outset, this object is achieved, according to the invention, by the fact that a parameter representing the cleaning condition of the beverage conduit is measured during the cleaning of said beverage conduit, and the cleaning process is terminated when the parameter reaches a predetermined setpoint value.

In a device of the kind mentioned at the outset, the object is achieved, according to the invention, by the fact that measuring unit are provided for measuring a parameter representing the cleaning condition of the beverage conduit during the cleaning of said beverage conduit, and terminating unit are provided which terminate the cleaning process when the parameter reaches a predetermined setpoint value.

The object on which the invention is based is achieved completely in this way. This is because, in contrast to the prior art, controlled cleaning and flushing take place in which the instantaneous state of cleaning and flushing is continuously recorded, and the cleaning is terminated, for example the cleaning agent removed, and the flushing terminated only when the cleaning and flushing satisfy a previously defined criterion.

In one illustrative embodiment of the invention, the parameter indicates an electrical conductivity.

This measure has the advantage that a parameter is here chosen which technically can be easily and reliably detected, in the simplest case in fact by a current/voltage measurement.

The electrical conductivity of a medium located in the beverage conduit is preferably determined, and also the electrical conductivity of a lining covering an inner surface of the beverage conduit.

This measure has the advantage of directly detecting the variable that is of actual interest for the cleaning, namely the coating in the beverage conduit.

Alternatively, however, the parameter can also indicate a turbidity or a pH value of a medium located in the beverage conduit.

In these variants, the cleaning condition is thus detected indirectly, namely via the medium located in the beverage conduit, for example the cleaning liquid. Proven and established measurement elements and methods can be used here. Of course, all the aforementioned parameter variants can also be combined with one another in order to increase the reliability of the measurement.

According to the invention, a particularly good result is achieved if, as setpoint value, a value representing a clean beverage conduit is determined in advance in the beverage conduit.

Here too, in contrast to the prior art, the user does not have to rely on previous experience and instead can employ objectively determined measurement values.

According to the invention, it is also preferred if, as the reference variable for the parameter, a parameter of a medium located in the beverage conduit is determined.

This measure has the advantage that, when measuring the parameter, a disturbance variable, namely the influence of the medium located in the beverage conduit, can be eliminated.

In this variant too, the setpoint value can be derived from the electrical conductivity, turbidity or pH value.

Finally, in a particularly preferred illustrative embodiment of the method according to the invention, the parameter is measured as first signal upstream, and as second signal downstream, of an addition device for the cleaning agent, and a flushing process taking place at the end of the cleaning process is terminated only when the signals are substantially identical.

This measure has the advantage that, at the end of the flushing process, it is guaranteed that there are no residues of cleaning agent left in the beverage conduit. There is therefore no danger involved in recommencing tapping operations, i.e. the beverage conduit can be filled with beverage.

In a preferred development of the device according to the invention, the measuring unit include at least two electrically conductive but mutually electrically insulated sections of the beverage conduit, and also a first measurement circuit for measuring the electrical conductivity between the two sections.

This measure has the advantage of affording a particularly simple configuration of the measuring unit, i.e. the sensor for measuring the parameter that represents the cleaning condition of the beverage conduit. The arrangement can be easily integrated into an existing beverage conduit and is easy to maintain and inexpensive to run.

Alternatively, or in addition, a turbidimeter or a pH meter can of course also be used here for example.

In a preferred embodiment of the device according to the invention, determining unit is provided for determining, in the beverage conduit, a parameter of a medium located in said beverage conduit.

If an electrical conductivity is determined, the determining unit includes a second measurement circuit, and they preferably have a further, electrically insulating section in the beverage conduit, preferably arranged between the two electrically conductive sections.

The advantages already discussed above are once again afforded, this time in respect of the determining unit.

Further advantages will become apparent from the description and from the attached drawing.

It will be appreciated that the features mentioned above and the features still to be explained below can be used not only in the respectively cited combination but also in other combinations or singly, without departing from the scope of the present invention.

It will also be appreciated that the features mentioned in the appended claims may be combined arbitrarily. The invention is not limited to the feature combinations according to the claims.

### BRIEF DESCRIPTION OF THE DRAWINGS

Illustrative embodiments of the invention are explained in more detail in the following description and are depicted in the drawing, in which:

FIG. 1 shows an extremely schematic representation of a dispensing system equipped with a device according to the invention;

FIG. 2 shows a schematic representation, partially in cross section, of an illustrative embodiment of a device according to the invention;

FIG. 3 shows a first equivalent electric circuit diagram explaining the device according to FIG. 1;

FIG. 4 shows a second equivalent electric circuit diagram explaining the device according to FIG. 1; and

FIG. 5 shows a schematic representation of a further illustrative embodiment of the invention.

### DETAILED DESCRIPTION OF PREFERRED EMBODIMENTS

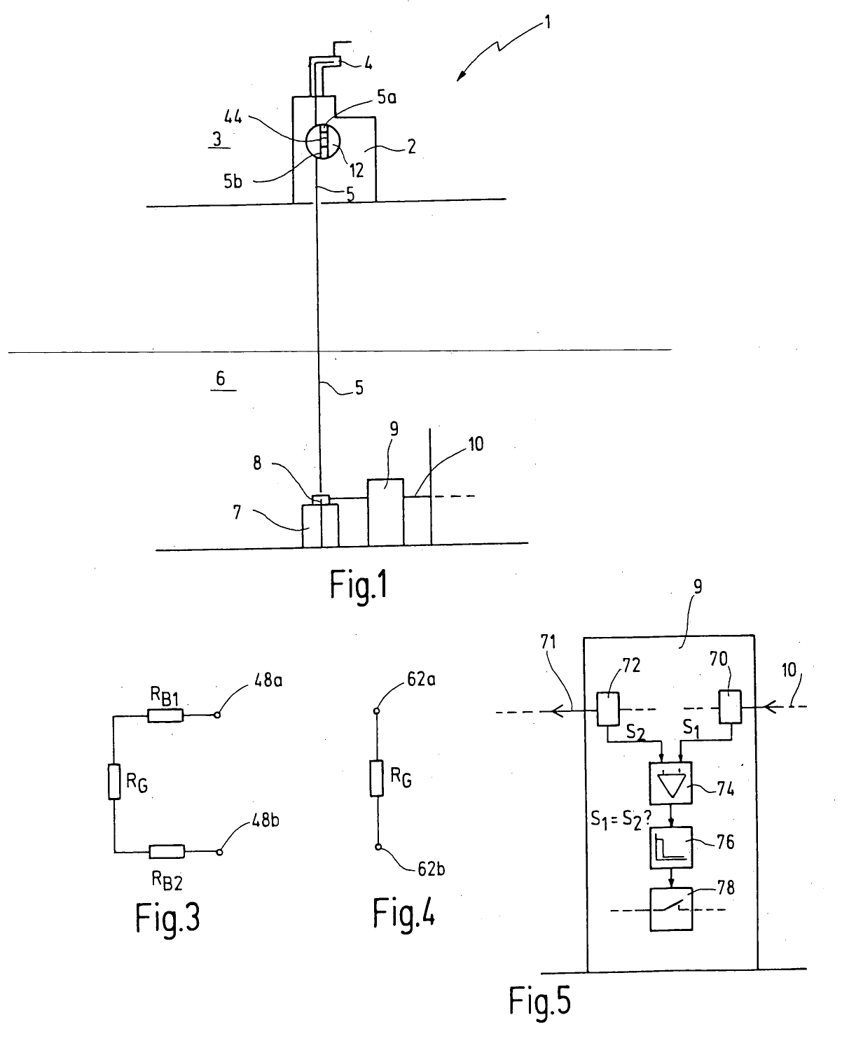

FIG. 1 is an extremely schematic representation of a dispensing system 1 such as is installed in pubs and restaurants, for example. The dispensing system 1 includes a counter 2 set up in a taproom 3. On the counter 2 there is a tap 4 with which beverages, in particular carbonated beverages, especially beer, can be tapped. From the tap 4, a beverage conduit 5 leads down into a cellar 6 in which a keg 7 or several such kegs are located. The beverage conduit 5 is connected to the keg 7 by means of a coupler 8. A cleaning system 9 is also usually linked up in the area of the coupler 8 and in turn communicates with a water supply system via a water conduit 10.

The cleaning system 9 is used to clean the beverage conduit 5. After it has been started up, it first ensures that the residual beverage located in the beverage conduit 5 is forced back into the keg 7 or emptied via the tap 4. The coupler 8 is then knocked off the keg 7. The cleaning system 9 now conveys a cleaning agent, namely a mixture of a cleaning agent concentrate and water, into the beverage conduit 5 until the latter is filled all the way to the tap 4. The cleaning agent is now left for a certain period of time in the beverage conduit 5 and is then removed again, for example drained off. The beverage conduit 5 is then flushed several times with water. Thereafter, tapping can commence again, i.e. the beverage conduit 5 can be filled with the beverage.

There are two important considerations here:

First, it must be guaranteed that the beverage conduit 5 has been completely cleaned. Second, it is also necessary to ensure that the beverage conduit 5 is completely free of cleaning agent after the flushing process.

This is where the invention comes into play.

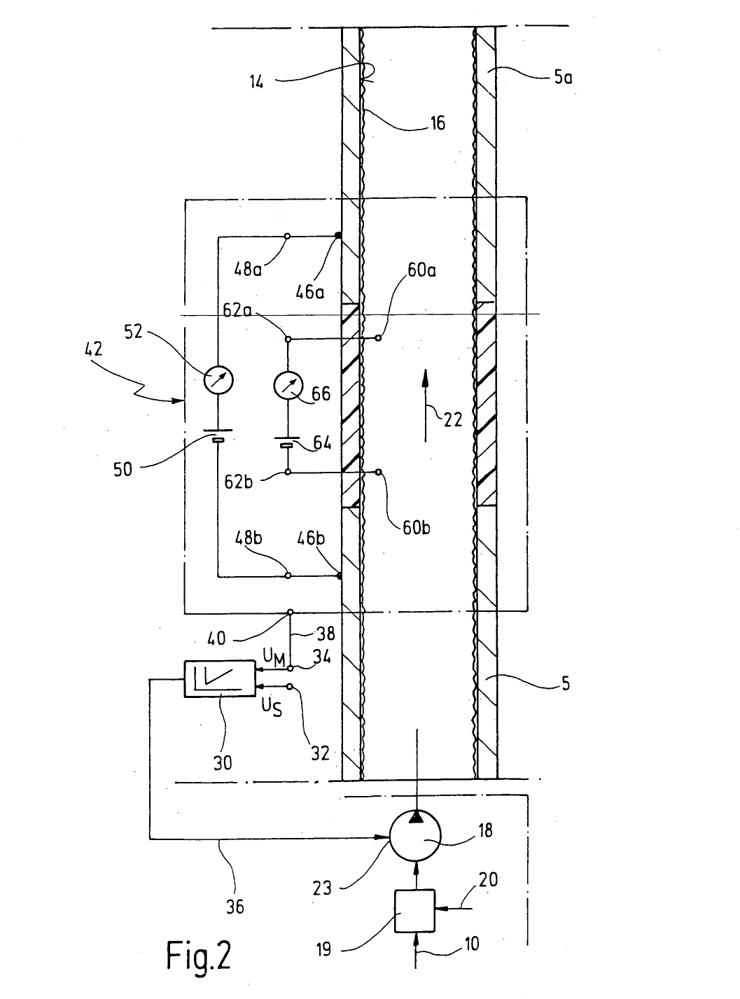

In FIG. 2, reference number 12 generally designates a first illustrative embodiment of a device according to the invention. The device 12 is located in the beverage conduit 5, as is already indicated as an enlarged detail in FIG. 1 in the area of the bar counter.

The beverage conduit 5 has a first section 5a and a second section 5b. Both sections are electrically conductive and are preferably made of special steel. A lining 16, consisting of deposits of the beverage in question, can be seen extending along an inner surface 14 of the conduit 5.

In order to clean the beverage conduit 5, a pump 18 or a pressure vessel or a pressure pipe is provided in the cleaning system 9.

In a metering device 19, water from the water conduit 10 is mixed with a cleaning agent concentrate supplied via a conduit 20, and, by means of the pump 18, this mixture is introduced as cleaning agent into the beverage conduit 5, as is indicated by an arrow 22. For the sake of clarity, the valves and valve controls needed for this have not been shown in detail, nor have the means for draining the cleaning agent off after cleaning has been completed.

It is important that the flow of cleaning agent 22 into the beverage conduit 5 is controllable, for example via the controllable pump shown in FIG. 1. Of course, “controllable” is to be understood as meaning all possible forms of metering, that is to say both continuous metering and also clocked metering. The metering can of course also be effected by corresponding valves in pressurized supply lines. The beverage conduit 5 is preferably emptied in a manner known per se at the start of the cleaning process and then filled with the cleaning agent, which is then left standing in the beverage conduit for as long as the cleaning process takes.

In the illustrative embodiment shown, a controllable pump 18 is used, as has already been mentioned. The latter is connected with its control input 23 to the output of a regulator 30.

A predetermined setpoint voltage U_{S} is fed to a first input 32 of the regulator 30, and a measured actual voltage U_{M} is fed to a second input 34. From these two input signals U_{S} and U_{M}, the regulator forms at its output a control signal, which is fed via an output line 36 to the pump 18.

The measured actual value voltage U_{M} is fed to the second input 34 via an output line 38 from an output terminal 40 of a sensor 42.

The sensor 42 includes parts of the electrically conductive sections 5a and 5b of the beverage conduit 5 and also an electrically insulating section 44 located between the sections 5a and 5b. It is important here that the two sections 5a and 5b are also not electrically connected to one another elsewhere.

A first measurement point 46a is located on the upper section 5a in FIG. 1, and a second measurement point 46b is located on the lower section 5b.

The measurement points 46a and 46b are linked to terminals 48a and 48b, respectively. Between these measurement points, a first current source 50 and a first ammeter 52 lie in series.

In the area of the further section 44 there are a third measurement point 60a and a fourth measurement point 60b, which are both arranged in the interior of the beverage conduit 5. These measurement points are linked through passages in the electrically insulating wall of the further section 44 to terminals 62a and 62b. Between these terminals 62a and 62b, a second current source 64 and a second ammeter 66 are connected in series.

The device 12 works in the following way:

With the measurement circuit 46-52 described first above, a current is generated which flows from the first measurement point 46a through the conductive wall of the upper section 5a, through the lining 16 located thereon, through the medium located in the beverage conduit 5, through the lining 16 in the area of the lower section 5b, through the latter's conductive wall, and onward to the second measurement point 46b.

The equivalent electric circuit diagram for this is shown in FIG. 3. It will be seen from this that, ignoring the electrical resistances of the electrical lines and of the walls of the electrically conductive sections 5a, 5b, a series circuit of three resistances is measured between the terminals 48a and 48b, namely the resistance R_{G} of the beverage and, twice, the resistance of the lining R_{B}. If R_{G} is known, it is possible to determine the resistance R_{B} from a measurement of the current by means of the first ammeter 52. The actual voltage U_{M} is then generated, in the manner known to a person skilled in the art, as a function of the measured resistance R_{B}, for example proportional thereto.

If R_{G} is not known, it is determined in an analogous manner using the second measurement circuit 60-66 described above, with the second ammeter 66 measuring the current flowing through the medium located in the beverage conduit. The equivalent electric circuit diagram between the terminals 62a and 62b is shown in FIG. 3.

When the beverage conduit 5 is to be cleaned, the residual beverage still located in the beverage conduit 5 is first removed. The beverage conduit 5 is then filled with the cleaning agent 22 by switching on the pump 18.

In a first variant, the cleaning agent 22 remains standing in the beverage conduit 5 in a customary manner, i.e. the pump 18 is then switched off. In a second variant, by contrast, the cleaning is carried out with continuous through-flow of the cleaning agent 22, i.e. with the pump continuously running. The same applies when the beverage conduit is supplied not via a pump 18 but instead via a valve control from a pressure pipe.

The value U_{M} is in each case continuously compared with the previously defined value U_{S}. When U_{M} has reached the value of U_{S}, the beverage conduit 5 is considered clean. The cleaning agent 22 is now forced out by pumping or is drained off. Flushing is then carried out, either in a conventional manner, i.e. with a number of flushing processes that is based on empirical values, or likewise controlled by the sensor 44 and regulator 30.

With the second measurement circuit 60-64, the electrical conductivity of the cleaning agent 22 can be determined if R_{G} is not known. FIG. 4 shows the associated equivalent circuit diagram. The value determined here can then be used to define R_{B}.

To calibrate the first measurement circuit 46-52, the value of U_{M} can be fixed, with the measurement conduit 5 completely cleaned, and can be used as setpoint value U_{S} in subsequent cleaning processes.

FIG. 5 shows a further illustrative embodiment of the invention which is used to ensure that the beverage conduit is free of cleaning agent residues after completion of the flushing process.

At the intake end of the cleaning system 9, the water conduit 10 has a first sensor 70, downstream of which the addition of the cleaning agent concentrate takes place and the pump 18 is arranged (not shown here). A second sensor 72 is located in an output conduit 71 leading to the beverage conduit 5 or to the coupler 8. The sensors 70 and 72 are preferably of the same configuration. They work, for example, according to the principle of conductivity measurement or turbidity measurement or pH measurement. The sensors generate signals S₁ and S₂ which, for example, represent the electrical conductivity at the input and output, respectively, of the cleaning system 9.

The sensors 70 and 72 are connected to a comparator 74, for example a difference amplifier. The latter's output is in turn connected to a threshold stage 76 which is tripped below a predeterminable threshold voltage and preferably detects the “zero” input voltage. The threshold stage 76 then actuates the switch 78, which terminates the cleaning program.

This arrangement works as follows:

As long as the beverage conduit 5 is being cleaned and cleaning agent concentrate is being added, the signals S₁ and S₂ differ. The output of the comparator 74 then lies at a finite level, and the threshold stage 76 is not tripped. It is only when, after successful flushing of the beverage conduit 5, there is no more addition of cleaning agent concentrate at the output of the cleaning system 9, in other words when the water from the water conduit 10 reaches the output conduit 71 unchanged, that S₁=S₂ and, consequently, the output signal of the comparator 74 is zero, with the result that the threshold stage 76 is tripped and actuates the switch 78. The effect of this is that a quantity of water is still conveyed through the beverage conduit 5 corresponding to the volume of the latter. The flushing process and thus also the cleaning process are thereby terminated, and it is guaranteed that no cleaning agent residues are any longer present in the beverage conduit. There is then no danger in recommencing tapping operations.

It will be appreciated that the electronic contacts shown in FIGS. 2 and 5 are only to be understood as examples. Their functions can of course also be assumed by software.

What is claimed, is:

1. A method for cleaning a beverage conduit in a dispensing system, in which method the beverage conduit is filled with a cleaning agent and cleaned, wherein a parameter (U_{M}; S₁, S₂) representing the cleaning condition of the beverage conduit is measured during the cleaning of said beverage conduit, and the cleaning process is terminated when the parameter (U_{M}; S₁, S₂) reaches a predetermined setpoint value (U_{S}; S₁=S₂).

2. The method as claimed in claim 1, wherein the parameter (U_{M}; S₁, S₂) indicates an electrical conductivity.

3. The method as claimed in claim 2, wherein the electrical conductivity of a medium located in the beverage conduit is determined, and also the electrical conductivity of a lining covering an inner surface of the beverage conduit.

4. The method as claimed in claim 1, wherein the parameter indicates a turbidity of a medium located in the beverage conduit.

5. The method as claimed in claim 1, wherein the parameter indicates a pH value of a medium located in the beverage conduit.

6. The method as claimed in claim 1, wherein, as setpoint value (U_{S}), a value representing a clean beverage conduit is determined in advance in the beverage conduit.

7. The method as claimed in claim 1, wherein, as reference quantity for the parameter, a parameter (R_{G}) of a medium located in the beverage conduit is determined.

8. The method as claimed in claim 7, wherein the parameter indicates an electrical conductivity.

9. The method as claimed in claim 7, wherein the parameter indicates a turbidity.

10. The method as claimed in claim 7, wherein the parameter indicates a pH value.

11. The method as claimed in claim 1, wherein the parameter is measured as first signal (S₁) upstream, and as second signal (S₂) downstream, of an addition device for the cleaning agent, and a flushing process taking place at the end of the cleaning process is terminated only when the signals (S₁, S₂) are substantially identical.

12. A device for cleaning a beverage conduit in a dispensing system, with a cleaning system for filling the beverage conduit with a cleaning agent, wherein a measuring unit is provided adapted to measure a parameter (U_{M}; S₁, S₂) representing the cleaning condition of the beverage conduit during the cleaning of said beverage conduit, and terminating unit is provided which is adapted o terminate the cleaning process when the parameter (U_{M}; S₁, S₂) reaches a predetermined setpoint value (U_{S}; S₁=S₂).

13. The device as claimed in claim 12, wherein the measuring unit includes at least two electrically conductive but mutually electrically insulated sections of the beverage conduit, and also a first measurement circuit for measuring the electrical conductivity between the two sections.

14. The device as claimed in claim 12, wherein the terminating unit includes a turbidimeter in the beverage conduit.

15. The device as claimed in claim 12, wherein the terminating unit includes a pH meter in the beverage conduit.

16. The device as claimed in claim 12, wherein a determining unit is provided adapted to determin, in the beverage conduit, a parameter of a medium located in said beverage conduit.

17. The device as claimed in claim 16, wherein the determining unit includes a measurement circuit for measuring the electrical conductivity of a medium located in the beverage conduit.

18. The device as claimed in claim 16, wherein the determining unit includes a turbidimeter for measuring the turbidity of a medium located in the beverage conduit.

19. The device as claimed in claim 16, wherein the determining unit includes a pH meter for measuring the pH value of a medium located in the beverage conduit.

20. The device as claimed in claim 16, wherein the determining unit is arranged in an electrically insulating further section of the beverage conduit.

21. The device as claimed in claim 20, wherein the parameter indicates a pH value of a medium located in the beverage conduit, and the further section is arranged between the two electrically conductive sections.

22. The device as claimed in claim 12, wherein sensors are provided for recording the parameter as first signal (S₁) upstream and as second signal (S₂) downstream of an addition device for the cleaning agent, and in that the sensors interact with a further terminating unit which is adapted to terminate a flushing process taking place at the end of the cleaning process only when the signals (S₁, S₂) are substantially identical.
